(19) United States
(12) Patent Application Publication
(10) Pub. No.: US 2011/0285290 A1
(43) Pub. Date: Nov. 24, 2011

(54) ELECTRONIC DEVICE

(75) Inventors: Jason Tyler GRIFFIN, Kitchener (CA); Todd Andrew WOOD, Guelph (CA)

(73) Assignee: RESEARCH IN MOTION LIMITED, Waterloo (CA)

(21) Appl. No.: 12/784,947

(22) Filed: May 21, 2010

(51) Int. Cl. H01K 7/00

(52) U.S. Cl. 315/76

(57) ABSTRACT

An electronic device is provided. The electronic device comprises a display and a display surround member located adjacent to a peripheral edge of the display and extending at least partially along the peripheral edge of the display. The display surround member comprises a colour change mechanism enabled to change the colour of the display surround member between a first colour and a second colour in response to an application being run on the portable electronic device.

### FIELD

The specification relates generally to an electronic device, and especially but not solely, to a portable electronic device.

### BACKGROUND

Portable electronic devices are generally designed with a specific use in mind, for example as a personal digital assistant (PDA) or as an e-book. Each of these uses usually has a display surround member, also known as bezels, and the colour of the bezel, or the contrast of the bezel relative to the display, is usually matched to the particular use. For example, PDAs tend to have bezels that are dark/black, to provide high contrast between the content of the PDA and the bezel, and e-books tend to have bezels that are light/white, to provide the appearance of book margins.

The current trends are for the functionality of portable electronic devices to converge so that one device performs multiple functions but this multiple functionality results in it being difficult to select a bezel colour that is suitable for all functions that the device is intended to perform.

### BRIEF DESCRIPTIONS OF THE DRAWINGS

Implementations are described with reference to the following figures, in which:

FIG. 1 depicts a front view of a portable electronic device portable electronic device having a colour change mechanism in a display surround member;

FIG. 2 depicts a block diagram of the portable electronic device of FIG. 1, according to non-limiting implementations;

FIG. 3 depicts front view of the portable electronic device of FIG. 1 running a first application and colour change mechanism changed to a first colour, according to non-limiting implementations;

FIG. 4 depicts front view of the portable electronic device of FIG. 1 running a second application and colour change mechanism changed to a second colour, according to non-limiting implementations;

FIG. 5 depicts front view of the portable electronic device of FIG. 1 operating in a landscape orientation and the colour change mechanism changed to a first colour, according to non-limiting implementations;

FIG. 6 depicts front view of the portable electronic device of FIG. 1 operating in a portrait orientation and the colour change mechanism changed to a second colour, according to non-limiting implementations;

FIG. 7 depicts a cross-section of a display surround member, and controlling circuitry, according to non-limiting implementations; and

FIG. 8 depicts a method for controlling contrast in a portable electronic device comprising a display device and display surround member comprising a colour change mechanism, according to non-limiting implementations.

### DETAILED DESCRIPTION

A first aspect of the specification provides an electronic device comprising: a display; and a display surround member located adjacent to a peripheral edge of the display and extending at least partially along the peripheral edge, the display surround member comprising a colour change mechanism enabled to change the colour of the display surround member between a first colour and a second colour in response to an application being run on the electronic device.

The application can be switched between at least one of a first category of applications and a second category of applications, the first colour associated with first category and the second colour associated with the second category.

The first category can comprise at least one of a video application, a personal digital assistant (PDA) application, an active application, an interactive application, a full functionality operational mode or application, a non-text application, multimedia application, a visual media application and a colour application, and the second category can comprise at least one of a no-video application, an e-book application, a static application, a non-interactive application, a limited functionality operational mode or application, a reduced functionality operational mode or application, a text application, an audio application and a black-and-white application.

The first colour can be associated with at least one of a full functionality operational mode and a high power state and the second colour can be associated with at least one of a reduced functionality operational mode and a lower power state.

The first colour can be associated with a full functionality application and the second colour can be associated with a reduced functionality application, wherein the electronic device has full functionality when the full functionality application is running and the electronic device has functionality that is less than full functionality when the reduced functionality application is running.

The first colour can be associated with a first orientation of the electronic device and the second colour can be associated with a second orientation of the electronic device. One of the first orientation and the second orientation can comprise a portrait orientation and the other of the first orientation and the second application can comprise a landscape orientation.

The portable electronic can further comprise a backlight, and the display can comprise a transflective display, wherein a first application can comprise a transmissive backlight-on application and a second application can comprise a reflective backlight-off application, a colour of the colour change mechanism dependent on the backlight being on or off.

The colour change mechanism can comprise a display portion enabled to electronically switch between at least the first colour and the second colour. The display portion can comprise at least one of a bistable display, an electronic paper display, an electrophoretic display, a electromagnetic fiber display, a bichromal display, a polyethylene sphere display, an electrofluidic display, a cholesteric liquid crystal display, and a bistable liquid crystal display. The display portion can comprise a single pixel surrounding the display connected to associated circuity for controlling the single pixel.

A first contrast caused by the first colour between the display surround member and the display can be higher than a second contrast between the display surround member and the display caused by the second colour.

The first colour can cause a high contrast between the display surround member and the display and the second colour can cause a low contrast between the display surround member and the display.

The first colour can cause the display surround member to appear black and the second colour can cause the display surround member to appear white.

The colour change mechanism can be further enabled to change the colour of the display surround member to at least a third colour in response to the application being run on the portable electronic device.

At least one of the first colour and the second colour can be formed by at least one of a solid colour and a pattern, and wherein each of the first colour and the second colour is static.

The portable electronic device can further comprise a processing unit in communication with the display surround member, the processing unit enabled to determine which application is currently being run at the portable electronic device.

The portable electronic device can further comprise a processing unit in communication with display device for implementing the application.

The portable electronic device can further comprise a switch for causing the colour change mechanism to switch between the first colour and the second colour.

A second aspect of the specification provides a method for controlling contrast in a electronic device including a display and a display surround member located adjacent to a peripheral edge of the display and extending at least partially along the peripheral edge, the display surround member comprising a colour change mechanism enabled to change the colour of the display surround member between a first colour and a second colour, the method comprising: controlling the colour change mechanism to switch between at least the first colour and the second in response to an application being run on the electronic device.

A third aspect of the specification provides a computer program product, comprising a computer usable medium having a computer readable program code adapted to be executed to implement a method for controlling contrast in a electronic device including a display and a display surround member located adjacent to a peripheral edge of the display and extending at least partially along the peripheral edge, said display surround member comprising a colour change mechanism enabled to change the colour of the display surround member between a first colour and a second colour, said method comprising: controlling said colour change mechanism to switch between at least said first colour and said second in response to an application being run on said electronic device.

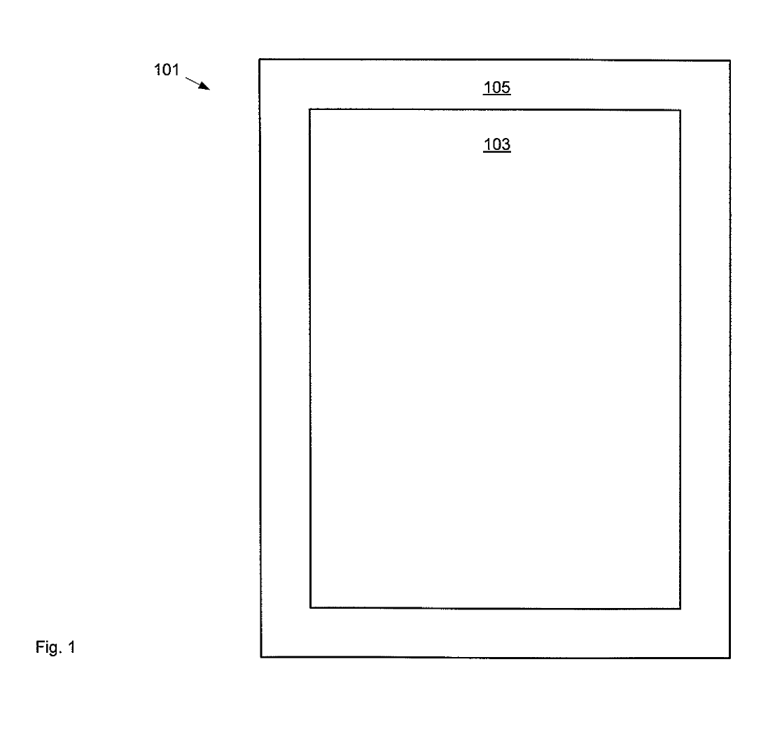

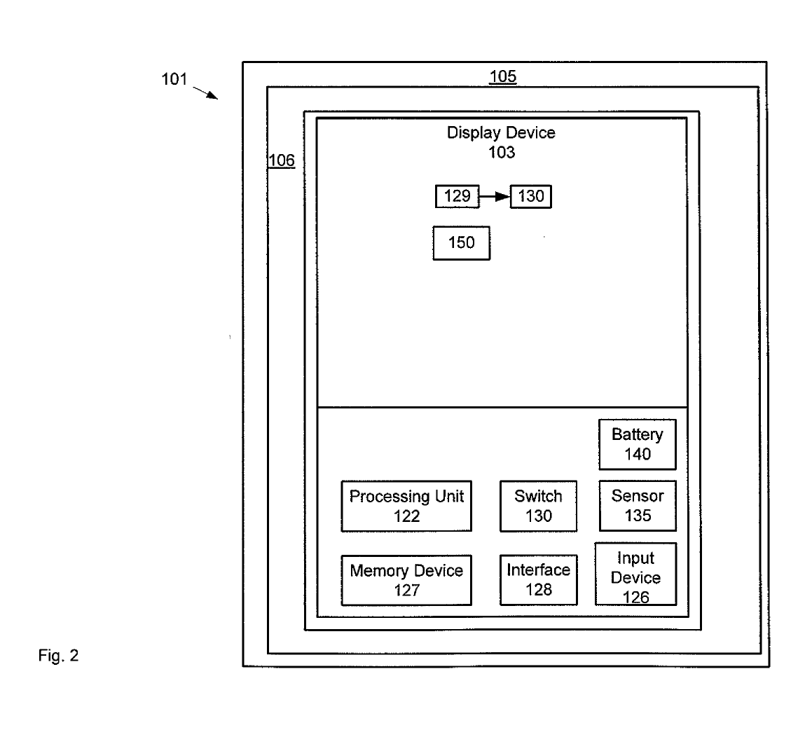

FIGS. 1 and 2 depict a portable electronic device 101, according to non-limiting implementations, comprising a display device 103 and a display surround member 105 located adjacent to a peripheral edge of display device 103 and extending at least partially along the peripheral edge. Display surround member 105 comprises a colour change mechanism 106 enabled to change the colour of display surround member 105 between a first colour and a second colour in response to an application being run on portable electronic device 101, as will be describe below. FIG. 1 depicts a front view of portable electronic device 101, showing only display device 103 and display surround member 105, while FIG. 2 depicts a block diagram of elements of portable electronic device 101. Portable electronic device 101 will also be referred to as device 101 in the following description.

As depicted in FIG. 2, portable electronic device 101 further comprises a processing unit 122 interconnected with display device 103, colour change mechanism 106, an input device 126, a memory device 127, and optionally with a communication interface 128, for example via a computing bus (not depicted). In some implementations, device 101 can further comprise a switch 130 for causing display device 103 to switch between at least a first application and a second application and/or for causing colour change mechanism 106 to change between at least a first colour and a second colour, as will be described in further detail below. In yet further implementations, device 101 can comprise a sensor 135 for detecting an orientation of device 101, as will be described in further detail below. Device 101 further comprises a battery 140 for powering device 101.

In general, portable electronic device 101 comprises any suitable portable computing device, including but not limited to any suitable combination of laptop computing devices, portable computing devices, mobile electronic devices, PDAs (personal digital assistants), cellphones, smartphones, e-books and the like. Other suitable portable electronic devices are within the scope of present implementations.

Different applications can be run on device 101, and display surround member 105 can change colours based on the application being run on device 101. For example the application can be switched between at least one of a first category of applications and a second category of applications, with a first colour of the colour change mechanism 106 being associated with the first category and a second colour associated with the second category. The first category can comprise at least one of video applications, personal digital assistant (PDA) applications, active applications, interactive applications, full functionality applications, non-text and colour applications. The second group can comprise at least one of no-video applications, e-book applications, static applications, non-interactive applications, limited functionality applications, reduced functionality applications, text applications and black-and-white applications.

In some implementations, the first colour can be associated with at least one an active application and the second colour can be associated with at least one static application; active applications can include rapid updating of data and/or representations displayed on display device 103, while static applications can include infrequent and/or or slow updating of data and/or representations displayed on display device 103. Hence, with active applications, the human eye an be adjusting frequently to changes on display device 103, while in static applications the human eye can be adjusting infrequently to changes on display device 103.

In further implementations, the first colour can be associated with at least one interactive application and the second colour can be associated with at least one non-interactive application. A non-interactive can comprise an application with limited interactivity and/or limited functionality and can also be associated with a limited interactive and/or limited functionality mode of device 101 and/or display 103. Non-limiting examples of non-interactive applications can include but are not limited to a sleep application and/or a sleep mode of device 101, a screen-saver application and/or a screen-saver mode of device 101, and/or an application where only information is displayed at display 103. It is appreciated that a non-interactive application can also comprise a low power application and/or a low power state of device 101 and/or display 103, and/or a low power mode of device 101 and/or display 103. Further non-limiting examples of a non-interactive application can include, but are not limited to an c-book type application, where “pages” can be “turned” but there is no scrolling function. Further non-limiting examples of a non-interactive application can include, but are not limited to, an audio application where device 101 has limited functionality beyond playing audio files. In some implementations, a non-interactive application can include applications where device 101 has reduced functionality, for example applications where at least one input device at device 101 is at least partially disabled (such as in the above described e-book application where an input device can be used to “turn pages” but not scroll). It is further appreciated that non-interactive applications can interchangeably be referred to as reduced functionality applications where the functionality of device 101 is reduced from full functionality.

An interactive application can include applications where device 101 has full functionality, such as a browser application, e-mail applications, document editing applications, visual media applications (that include viewing and/or playing visual media).

In yet further implementations the first colour is associated with a full functionality operational mode of device 101 and/or an interactive mode of device 101; and the second colour is associated with a reduced functionality operational mode of device 101 and/or a non-interactive mode of device 101. A full functionality operation mode can include, but is not limited to, modes of operation of device 101 where device 101 is fully functional: for example, all input devices and features are available for use at device 101. A reduced functionality operational mode of device 101 can include, but is not limited to, modes of operation of device 101 where the functionality of device 101 is reduced from full functionality: for example, at least one input device and/or at least one feature of device 101 is at least partially disabled. Non-limiting examples of reduced functionality operational modes and/or non-interactive modes can include an e-book mode and a mode where device 101 displays only a given set of information, such as a current time, current weather, and/or the like.

In yet further implementations the first colour is associated with a high power state of device 101 and the second colour is associated with a low power state of device 101. A non-limiting example of a high power state can be a state where backlight 150 is operational. A non-limiting example of a lower power state can be a state where backlight 150 is off. It is appreciated that a high power state device 101 can comprise a in a fully functional operational mode, and a lower power state of device 101 can comprise a reduced functionality operational mode. Other high power states and lower power states of device 101 are within the scope of present implementations.

In some implementations, the first colour can be associated with at least one non-text application and the second colour can be associated with at least one text application. Non-limiting examples of a non-text application can include but are not limited to at least one of a browser application and a visual media application. Non-limiting examples of a text application can include but are not limited to at least one of an e-book application, an email application, and a word processing application

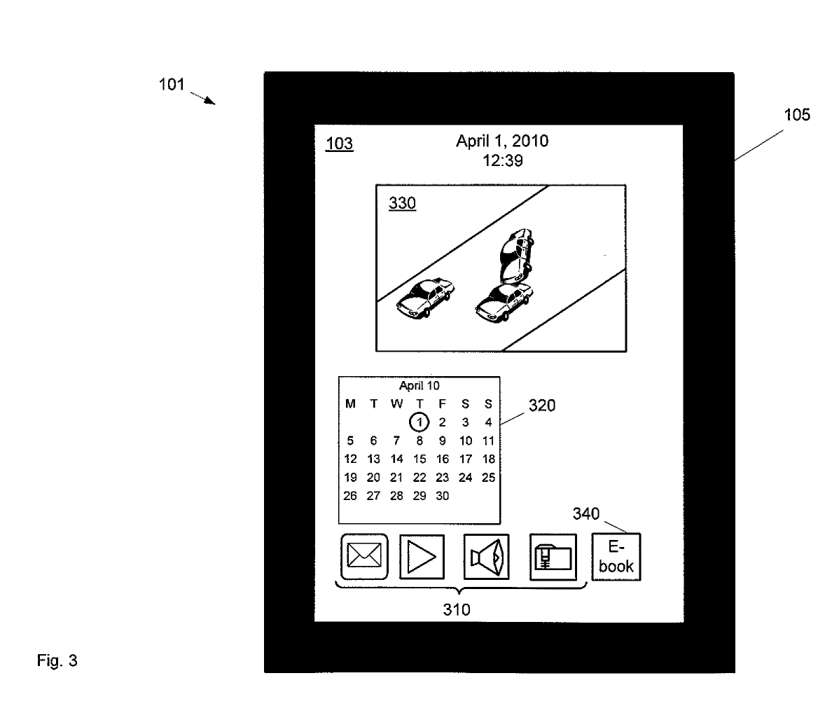

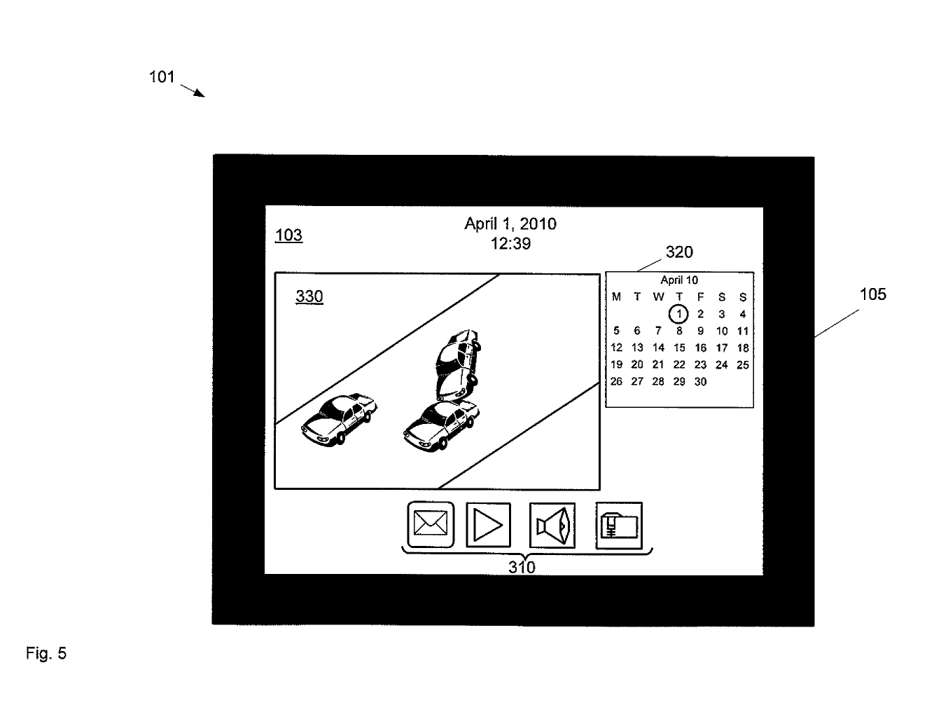

In yet further implementations, the first colour can be associated with a first orientation of device 101, such as a landscape orientation, and said second colour is associated with a second orientation of device 101, such as a portrait orientation. In some implementations, the orientation of device 101 can be determined via sensor 135. In other implementations, the orientation of device 101 can be determined from an application being run at device 101. For example, a landscape orientation application can comprise an application where data displayed at display 103 is provided in a landscape orientation, as depicted in FIG. 5, described below; similarly, a portrait orientation application can comprise an application where data displayed at display 103 is provided in a portrait orientation, as depicted in FIGS. 3, 4 and 6, described below. Hence, in these implementations, processing unit 122 can be enabled to determine the type of application being run at device 101, either a landscape orientation application or a portrait orientation application, and cause display surround member 105 to change to the first colour or the second colour, respectively. Furthermore, processing unit 122 can be enabled to determine an orientation of data being provided at display device 103 based on display cache data (i.e. data stored in a display cache, not depicted) and/or how display device 103 is being controlled to display data. In further implementations, the colour of display change member 105 can be based on at least one threshold value. For example, display change member 105 can be controlled to the first colour when an application being run at device 101 causes a portion and/or a percentage of display device 103 to be providing multimedia data, wherein the portion and/or the percentage is equal to or greater than a given threshold value. Similarly, display change member 105 can be controlled to the second colour when the portion and/or percentage is below the given threshold value, or below a second threshold value. Threshold values can also be based on changes to pixels in display device 101 (e.g. display surround member 105 is controlled to the first colour when pixels updates are above a threshold value, and controlled to the second colour when pixel updates are below a threshold value), a refresh rate of display device 101, or the like.

In yet further implementations, display device 103 can be enabled to switch between at least a first operational mode and a second operational mode, each of the first operational mode and the second operational mode dependent on an application being implemented in device 101. For example, in some implementations, device 101 can be implementing a PDA application, while in other implementations, device 101 can be implementing an e-book application. Hence, when device 101 is implementing a PDA application, display device 103 can be operated in a video mode and/or a colour mode and/or an active mode. When device 101 is implementing an e-book application, display device 103 can be operated in a no-video mode and/or a black-and-white mode and/or a static mode.

In some implementations, as display device 103 switches between modes, display surround member 105 can change colours to change the contrast between display surround member 105 and display device 103. Indeed, it is appreciated that display surround member 105 generally surrounds display device 103, and that display surround member 105 can be enabled to switch between at least a first contrast mode and a second contrast mode, relative to display device 103, dependent the application being run on device 101. Each of the contrast modes are based on the colour of the display surround member 105.

For example, when display device 103 running a PDA application, the colour change mechanism 106 changes the colour of the display surround member 105 to a first colour in a first contrast mode, as in FIG. 3, the first colour in these implementations being black. The black border provided by display surround member 105, in the first contrast mode, provides a high and/or expected contrast between the content provided on display device 103 in the PDA mode. FIG. 3 further depicts representations of icons 310, which can be actuated to implement PDA-associated applications, a calendar application 320 and a video window 330, which can be provided at display device 103 in PDA mode. It is appreciated that the number and/or type of icons and/or PDA applications and/or windows is not to be considered particularly limiting.

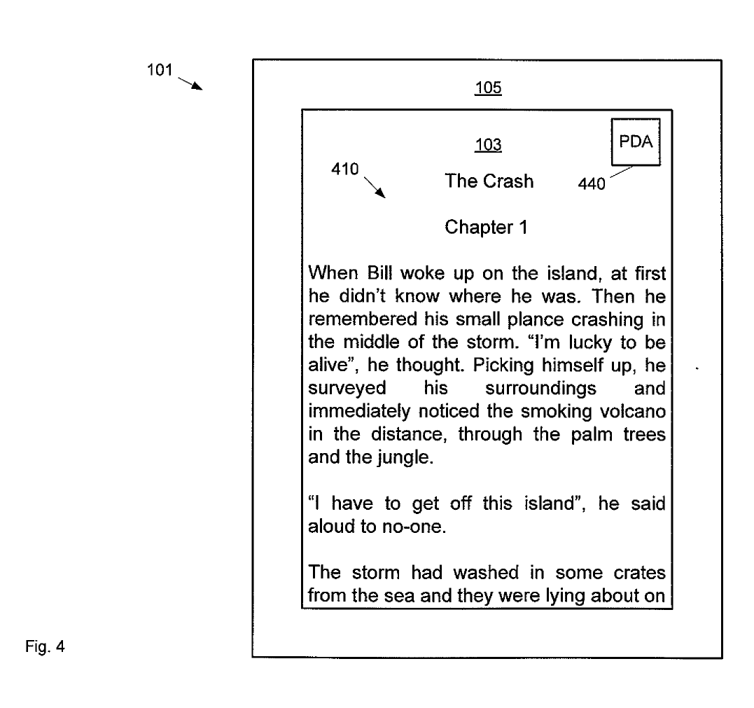

FIG. 3 further depicts an e-book icon 340, which can be provided at display device 103 in PDA mode, according to non-limiting implementations. Actuation of e-book icon 340 causes display 101 to switch from running the PDA application to running an e-book application and colour change mechanism 106 changes the colour of the display surround member 105 to a second colour in a second contrast mode, as depicted in FIG. 4. For example, when display device 103 is in an e-book mode, display surround member 105 can appear white as in FIG. 4. FIG. 4 further depicts representations of text 410 which can be provided at display device 103 when in e-book mode. The white border provided by display surround member 105 in second contrast mode provides a low and/or expected contrast between the background on which text 410 appears on display device 103 in the e-book mode. For example, the white border provided by display surround member 105 in second contrast mode appears to extend the margins of the “page” of the e-book to the outside edge of display surround member 105, much like in a real book.

FIG. 4 further depicts a PDA icon 440, which can be provided at display device 103 when display 101 is running the in e-book application, according to non-limiting implementations. Actuation of icon 440 causes device 101 to switch from running the e-book application to running the PDA application and colour change mechanism 106 changes the colour of the display surround member 105 back to the first colour in the first contrast mode, as depicted in FIG. 3.

As described above, icons 340, 440 can be used to switch back and forth between applications and associated colours and contrast modes of display surround member 105. For example, icons 340, 440 can be actuated via input device 126. In some implementations, actuation of icons 340, 440 causes switch 130 to activate, hence switching colour change member 106 to change the colour of display surround member 105. However, in other implementations, switching is controlled by processing unit 122, and switch 130 is absent from device 101; in these implementations, actuation of icons 340, 440 causes processing unit 122 to control change mechanism 106 to change the colour of display surround member 105. In yet further implementations, processing unit 122 and switch 130 can be combined, and actuation of icons 340, 440 causes processing unit 122 and/or switch 130 to control change mechanism 106 to change the colour of display surround member 105. In some implementations, actuation of icons 340, 440 causes processing unit 122 and/or switch 130 to control display device 103 to switch between operational modes.

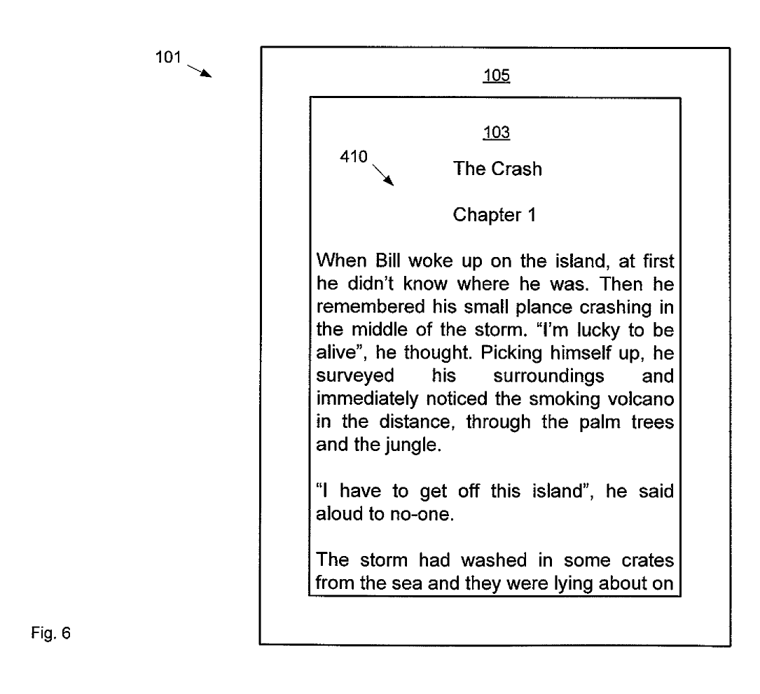

However, in other implementations, the operational mode of display device 103 can be determined by an orientation of device 101, as detected by sensor 135. For example, sensor 105 can be enabled to detect whether device 101 is in a portrait orientation or a landscape orientation. In these implementations, a given orientation can be associated with a given operational mode and/or a given application running on device 101. For example, a landscape orientation can be associated with a PDA application, as in FIG. 5, which is substantially similar to FIG. 3, with like elements having like numbers, except that device 101 is an a landscape mode. In these implementation, when device 101 is in a landscape orientation, device 101 runs a PDA application and display surround member 105 is changed to a first colour (e.g. black), which can include a first contrast mode. Accordingly, when device 101 is in a portrait orientation, device 101 runs an e-book application and display surround member 105 is changed to a second colour (e.g. white), which can include a second contrast mode, as depicted in FIG. 6 (substantially similar to FIG. 4 with like elements having like numbers). Furthermore, icon 340 is not in FIG. 5 and icon 440 is not in FIG. 6, as it is the orientation of device 101, as detected by sensor 135, which determines which application is run at device 101 and/or a colour of display surround member 105.

Elements of device 101 are now described in further detail with reference to FIGS. 1 and 2.

Processing unit 122 comprises any suitable processor, or combination of processors, including but not limited to a microprocessor, a central processing unit (CPU) and the like. Other suitable processing units are within the scope of present implementations. Processing unit 122 is generally enabled to determine which application is currently being run at device 101, for example by detecting selection of icon 340, 440 at input device 126 and/or by receiving data from sensor 135. Processing unit 122 is further enabled to implement applications at device 101, for example PDA applications and e-book applications. Processing unit 122 is further enabled to control display device 103 and/or switch 130 and/or colour change mechanism 106 and/or display surround member 105 to cause display device 103 to switch between operational modes and/or to cause colour change mechanism 106 to change the colour of display surround member 105.

Display device 103 comprises circuitry 129 for generating representations of data, for example a representation 130 of PDA applications, as depicted in FIGS. 3 and 5 and e-book applications, as depicted in FIGS. 4 and 6, as described above. Display device 103 can include any suitable one of or combination of CRT (cathode ray tube) and/or flat panel displays (e.g. LCD (liquid crystal display), plasma, OLED (organic light emitting diode), capacitive or resistive touchscreens, electronic paper displays, and the like. Circuitry 129 can include any suitable combination of circuitry for controlling the CRT and/or flat panel displays etc., including but not limited to display buffers, transistors, electron beam controllers, LCD cells, plasmas cells, phosphors etc. In particular, display device 103 and circuitry 129 can be controlled by processing unit 122 to generate representation 130.

In some implementations, display device 103 comprises a backlight 150, the light from which is modulated in display device 103 to form representation 130. In some of these implementations, display device 103 comprises a transflective display, backlight 150 being on when display device 103 is in a transmissive mode, and backlight 150 being off when display device 103 is in a reflective mode. In some of these implementations, a first operational mode of display device 103 can comprise a transmissive backlight-on mode and a second operational mode of display device 103 can comprise a reflective backlight-off mode. For example, when a PDA application is being run at device 101, and display device 103 is in a PDA mode, display device 103 can be in a transmissive backlight on mode; and when an e-book application is being run at device 101, and display device 103 is in an e-book mode, display device 103 can be in a reflective backlight off mode.

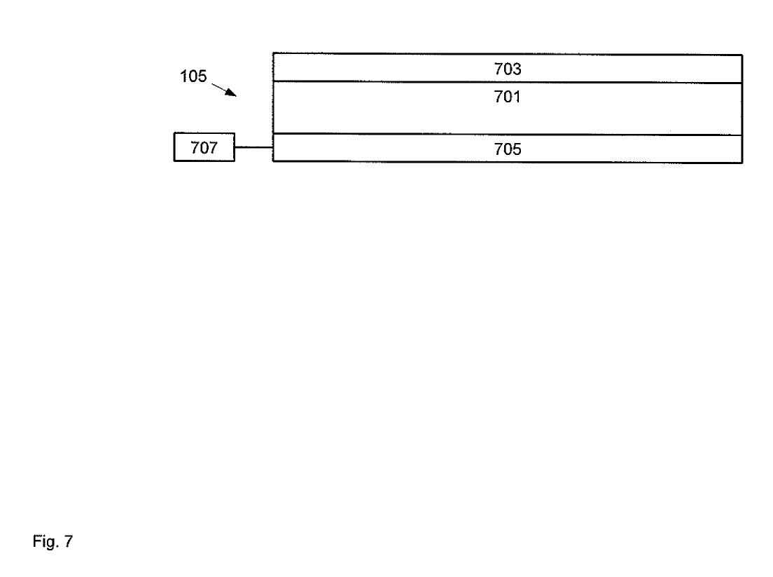

Display surround member 105 generally comprises a display bezel or any other suitable border adjacent to a peripheral edge of display 103 and extending at least partially along the peripheral edge of display 103. Furthermore colour change mechanism 106 comprises any suitable device for switching between contrast modes. In particular non-limiting implementations, display surround member 105 as depicted in cross section in FIG. 7, can comprise a display portion 701, protected by a generally transparent case 703, with colour change mechanism 106 comprising display portion 701. Display portion 701 is enabled to electronically switch between at least the first colour and the second colour to change the colour of the display surround member 105. For example, display portion 701 can comprises at least one of a bistable display, an electronic paper display, an electrophoretic display, a electromagnetic fiber display, a bichromal display, a polyethylene sphere display, an electrofluidic display, a cholesteric liquid crystal display, and a bistable liquid crystal display. In other words display portion 701 can be controlled to switch between the first colour (such as black) and the second colour (such as white), and maintain the respective colour using little or no power from battery 140, which is a general property of bistable displays. Hence, once display surround member 105 changes colour, then display surround member 105 generally holds that colour for a period of time, with little to no effect on the lifetime of battery 140. Further, there is no need for fast switching in display portion 701, or other properties associated with higher performance displays.

To further simplify display surround member 105, display portion 701 can comprises a single pixel surrounding display device 103 and associated circuitry 707 for controlling the single pixel. In other words, while displays generally comprise a plurality of pixels to form images, in present implementations, display surround member 105 is switched uniformly between colours without forming images thereon. Hence, display portion 701 can be configured as one large pixel, with a single back electrode 705, connected to circuitry 707 for switching between colours. Circuitry 707 can comprise any suitable circuitry for controlling display portion 701 similar to circuitry 129.

However, colour change mechanism 106 is not to be limited to display portion 701. Indeed, colour change mechanism 106 can comprise any suitable colour change mechanism for changing a colour of display surround member 105 including but not limited to any suitable combination of lights, LEDs (light emitting diodes), emissive materials, emissive apparatus, reflective materials, shutters or the like.

In some implementations, colour change mechanism 106 can be enabled to change display surround member 105 to at least a third colour in response to an application being run at device 101. Similarly changing display surround member 105 to at least a third colour causes display surround member 105 to enter at least a third contrast mode, relative to display device 103, a third contrast caused by third contrast mode between a first contrast caused by the first colour and a second contrast caused by the second colour. For example, display surround member 105 can be controlled to at least one shade of grey. In some implementations, the third colour can be achieved by controlling the colour of display portion 701, for example when display portion 701 comprises a cholesteric liquid crystal display. In other implementations, display portion 701 can comprise a plurality of pixels and the third colour can be achieved by controlling display portion 701 to form a pattern which, viewed from a suitable distance, appears to be the third colour. In yet further implementations, the third colour can comprise any suitable pattern provided at display portion 701, including but not limited to a regular pattern.

In any event, in implementations that include at least a third colour (or contrast mode), device 101 can run at least a third application. For example, in addition to a PDA application and an e-book application, device 101 can run a digital picture frame application and display surround member 105 can change to the third colour to provide a suitable contrast between display surround member 105 and pictures provided on display device 103: e.g. display surround member 105 could be controlled to have the appearance of a bevelled matte, and hence having a narrow border of white surrounding display device 103 and a wider, darker border surrounding the narrow border of white.

The third colour can be triggered when device 101 is running the associated application e, for example via actuation of an icon similar to icons 340, 440, and/or any other suitable method.

Input device 126 is generally enabled to receive input data, and can comprise any suitable combination of input devices, including but not limited to a keyboard, a keypad, a pointing device, a mouse, a track wheel, a trackball, a touchpad, a touch screen and the like. Other suitable input devices are within the scope of present implementations. In particular, input device 126 can be enabled for selection of icons 340, 440, as well as icons 310, calendar application 320 and/or video window 330. It is further appreciated that input device 126 enables control of PDA applications and e-book applications. Furthermore, it is appreciated that while input device 126 is not specifically depicted FIG. 1, input device 126 can be adjacent display device 103, and/or display surround member 105 and/or surrounded by display surround member 105. However, in implementations where input device 126 comprises a touchscreen, input device 126 can be incorporated into display device 103.

Memory device 127 can comprise any suitable memory device, including but not limited to any suitable one of or combination of volatile memory, non-volatile memory, random access memory (RAM), read-only memory (ROM), hard drive, optical drive, flash memory, magnetic computer storage devices (e.g. hard disks, floppy disks, and magnetic tape), optical discs, and the like. Other suitable memory devices are within the scope of present implementations. In particular, memory device 127 is enabled to store PDA applications, e-book applications, and any associated data.

Communication interface 128, when present, can comprise any suitable communication interface, or combination of communication interfaces. In particular communication interface 128 can be enabled to communicate with remote computing device via a network (not depicted) to receive messages, the network being wired and/or wireless as desired. Accordingly, communication interface 128 is enabled to communicate according to any suitable protocol which is compatible with the network, including but not limited to wired protocols, USB (universal serial bus) protocols, serial cable protocols, wireless protocols, cell-phone protocols, wireless data protocols, Bluetooth protocols, NFC (near field communication) protocols and/or a combination, or the like. In some implementations, communication interface 128 can be enabled to communicate with remote computing devices (e.g. servers, other computing devices, other mobile electronic devices, etc.), via any suitable communication network according to any suitable protocol, including but not limited to packet based protocols, Internet protocols, analog protocols, PSTN (public switched telephone network) protocols, WiFi protocols, WiMax protocols and the like, and/or a combination. Other suitable communication interfaces and/or protocols are within the scope of present implementations.

Switch 130 can comprise any suitable combination of hardware and software switches for switching colour change member 106 between colours and/or switching display device 103 between operational modes. In some implementations, switch 130 can be combined with processing unit 122 and/or circuitry 129 and/or circuitry 707.

Sensor 135 can comprise any suitable sensor, including but not limited to any suitable accelerometer.

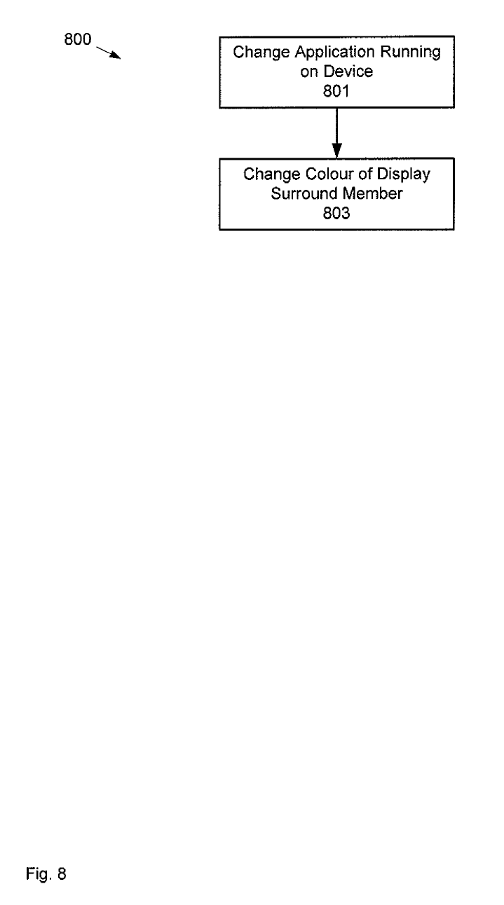

Attention is now directed to FIG. 8 which depicts a method 800 for controlling contrast in a portable electronic device. In order to assist in the explanation of method 800, it will be assumed that method 800 is performed using device 101. Furthermore, the following discussion of method 800 will lead to a further understanding of device 101 and its various components. However, it is to be understood that device 101 and/or method 800 can be varied, and need not work exactly as discussed herein in conjunction with each other, and that such variations are within the scope of present implementations.

At step 801, an application running on device 101 is changed. Step 101 is triggered, for example, by device 101 changing between running a first application and a second application (e.g. between running a PDA application and an e-book application).

At step 803, a colour of display surround member 105 is responsively changed between at least a first colour and a second colour, depending on the application being run on device 101. Accordingly, display surround member 105 also changes contrast modes, relative to display device 103, dependent on the application being run at display device 101. In some implementations, display surround member can switch between colours and/or contrast modes based on which of at least a first operational mode and a second operational mode is currently operational at display device 103.

Hence, by providing a portable electronic device with display surround member enabled to switch between colours via a colour change mechanism, responsive to a change in an application being run on the portable electronic device, the portable electronic device can operate in different visual modes suitable to an application being run on the portable electronic device. Hence, as the functionality of portable electronic devices converge, contrast between the display of the portable electronic device and the display surround member can be controlled to provide a suitable human machine interface.

Those skilled in the art will appreciate that in some implementations, the functionality of device 101 can be implemented using pre-programmed hardware or firmware elements (e.g., application specific integrated circuits (ASICs), electrically erasable programmable read-only memories (EEPROMs), etc.), or other related components. In other implementations, the functionality of device can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Alternatively, the computer-readable program code could be stored remotely but transmittable to these components via a modem or other interface device connected to a network (including, without limitation, the Internet) over a transmission medium. The transmission medium can be either a non-wireless medium (e.g., optical and/or digital and/or analog communications lines) or a wireless medium (e.g., microwave, infrared, free-space optical or other transmission schemes) or a combination thereof.

A portion of the disclosure of this patent document contains material which is subject to copyright protection. The copyright owner has no objection to the facsimile reproduction by any one the patent document or patent disclosure, as it appears in the Patent and Trademark Office patent file or records, but otherwise reserves all copyrights whatsoever.

Persons skilled in the art will appreciate that there are yet more alternative implementations and modifications possible for implementing the implementations, and that the above implementations and examples are only illustrations of one or more implementations. The scope, therefore, is only to be limited by the claims appended hereto.

1. An electronic device comprising:
a display; and
a display surround member located adjacent to a peripheral edge of said display and extending at least partially along the peripheral edge, said display surround member comprising a colour change mechanism enabled to change the colour of said display surround member between a first colour and a second colour in response to an application being run on said electronic device.

2. The electronic device of claim 1, wherein said application is switched between at least one of a first category of application and a second category of application, said first colour associated with first category and said second colour associated with said second category.

3. The electronic device of claim 2, wherein said first category comprises at least one of a video application, a personal digital assistant (PDA) application, an active application, an interactive application, a full functionality application, a non-text application, a multimedia application, a visual media application, and a colour application, and said second category comprises at least one of a no-video application, an e-book application, a static application, a non-interactive application, a limited functionality application, a reduced functionality application, a text application, an audio application and a black-and-white application.

4. The electronic device of claim 1, wherein said first colour is associated with at least one of a full functionality operational mode and a high power state and said second colour is associated with at least one of a reduced functionality operational mode and a lower power state.

5. The electronic device of claim 1, wherein said first colour is associated with a first orientation of said electronic device and said second colour is associated with a second orientation of said electronic device.

6. The electronic device of claim 5, wherein one of said first orientation and said second orientation comprises a portrait orientation and the other of said first orientation and said second orientation comprises a landscape orientation.

7. The electronic device of claim 1, further comprising a backlight, and said display comprises a transflective display, wherein a first application comprises a transmissive backlight-on application and a second application comprises a reflective backlight-off application, a colour of said colour change mechanism dependent on said backlight being on or off.

8. The electronic device of claim 1, wherein said colour change mechanism comprises a display portion enabled to electronically switch between at least said first colour and said second colour.

9. The electronic device of claim 8, wherein said display portion comprises at least one of a bistable display, an electronic paper display, an electrophoretic display, a electromagnetic fiber display, a bichromal display, a polyethylene sphere display, an electrofluidic display, a cholesteric liquid crystal display, and a bistable liquid crystal display.

10. The electronic device of claim 8, wherein said display portion comprises a single pixel surrounding said display connected to associated circuity for controlling said single pixel.

11. The electronic device of claim 1, wherein a first contrast between said display surround member and said display caused by said first colour is higher than a second contrast between said display surround member and said display caused by said second colour.

12. The electronic device of claim 1, wherein said first colour causes a high contrast between said display surround member and said display and said second colour causes a low contrast between said display surround member and said display.

13. The electronic device of claim 1, wherein said first colour causes said display surround member to appear black and said second colour causes said display surround member to appear white.

14. The electronic device of claim 1, wherein said colour change mechanism is further enabled to change the colour of said display surround member to at least a third colour in response to said application being run on said electronic device.

15. The electronic device of claim 1, wherein at least one of said first colour and said second colour is formed by at least one of a solid colour and a pattern, and wherein each of said first colour and said second colour is static.

16. The electronic device of claim 1, further comprising a processing unit in communication with said display surround member, said processing unit enabled to determine which said application is currently being run at said electronic device.

17. The electronic device of claim 1, further comprising a processing unit in communication with display device for implementing said application.

18. The electronic device of claim 1, further comprising a switch for causing said colour change mechanism to switch between said first colour and said second colour.

19. A method for controlling contrast in a electronic device including a display and a display surround member located adjacent to a peripheral edge of the display and extending at least partially along the peripheral edge, said display surround member comprising a colour change mechanism enabled to change the colour of the display surround member between a first colour and a second colour, said method comprising:
controlling said colour change mechanism to switch between at least said first colour and said second in response to an application being run on said electronic device.

20. A computer program product, comprising a computer usable medium having a computer readable program code adapted to be executed to implement a method for controlling contrast in a electronic device including a display and a display surround member located adjacent to a peripheral edge of the display and extending at least partially along the peripheral edge, said display surround member comprising a colour change mechanism enabled to change the colour of the display surround member between a first colour and a second colour, said method comprising:
controlling said colour change mechanism to switch between at least said first colour and said second in response to an application being run on said electronic device.
